(19) United States
(12) Patent Application Publication
(10) Pub. No.: US 2018/0283321 A1
(43) Pub. Date: Oct. 4, 2018

(54) SYSTEM FOR FEEDING LIQUID PROPELLANTS TO COMBUSTION CHAMBER OF AN ENGINE

(71) Applicant: INDEPENDENCE-X AEROSPACE SDN BHD, Seri Kembangan (MY)

(72) Inventor: Mohd Izmir BIN YAMIN, Seri Kembangan (MY)

(73) Assignee: INDEPENDENCE-X AEROSPACE SDN BHD, Seri Kembangan (MY)

(21) Appl. No.: 15/934,901

(22) Filed: Mar. 23, 2018

(30) Foreign Application Priority Data
Mar. 24, 2017 (MY) PI 2017701026

(51) Int. Cl. F02K 9/46; F02K 9/56

(52) U.S. Cl. CPC F02K 9/46; F02K 9/563

(57) ABSTRACT

A system for feeding a liquid fuel and a liquid oxidiser to combustion chamber of an engine, includes two containers kept under a low temperature, one for holding liquid hydrogen, and the other for holding liquid oxygen. Each of two expansion valves is connected to one separate container of said two containers, for transforming liquid hydrogen and liquid oxygen which pass through said valves, into gaseous forms. A fuel cell is connected to the valves for receiving the gaseous hydrogen and gaseous oxygen, and generating electric power. The system includes two other containers, one for holding the fuel, and the other for holding the oxidizer. Two electric pumps are connected to the two other containers, such that one of the pumps is capable of feeding the fuel, and the other is capable of feeding the oxidizer to the chamber, using the power generated by the fuel cell.

This invention relates to a system for feeding liquid propellants to combustion chamber of an engine, more especially, a rocket engine.

### BACKGROUND OF THE INVENTION

Propelling a huge vehicle such as rocket requires a powerful engine. There are two main categories of engines which cater for such requirement, i.e. liquid- and solid-propellant engines. Liquid-propellant engine is desirable over the solid counterpart because liquid propellants, which may include a liquid fuel and a liquid oxidiser, have high densities, and tanks of relatively small volume can be used to carry them. The liquid propellants can be stored in low-mass tanks under a low pressure, and pumped to the combustion chamber during operation, so that a high mass ratio can be achieved for the vehicle.

Existing systems employ turbopumps for pumping the propellants. Turbopumps, which use hot exhaust gas to rotate turbines, have the drawbacks of being heavy and expensive. Other existing systems employ battery-powered pumps for pumping the propellants. However, batteries have a low energy density, and take up a huge volume, and contribute to a huge mass, of the vehicle. As a result, systems which employ turbopumps or battery-powered pumps have relatively low thrust-to-weight ratios.

### SUMMARY OF THE INVENTION

The above-mentioned drawbacks are overcome, and improvements are achieved, by a system for feeding a liquid fuel and a liquid oxidiser to combustion chamber of an engine, which comprises: two containers kept under a low temperature, one for holding liquid hydrogen, and the other one for holding liquid oxygen; two expansion valves each connected to one separate container of said two containers, for transforming liquid hydrogen and liquid oxygen which pass through said valves, into gaseous forms; a fuel cell connected to said valves, for receiving the gaseous hydrogen and gaseous oxygen, and generating electric power; two other containers, one for holding the fuel, and the other one for holding the oxidiser; and two electric pumps connected to said two other containers, such that one of said pumps is capable of feeding the fuel, and the other one is capable of feeding the oxidiser, to the chamber, using the power generated by said fuel cell.

Preferably, the system also comprises one other container connected to said two other containers, for holding at least one inert gas, and supplying the gas to said two other containers for pushing the fuel to said fuel pump and the oxidiser to said oxidiser pump.

Advantageously, the temperature is in a range of −190° C. to −180° C.

Preferably, said fuel cell includes proton exchange membrane.

Advantageously, the fuel is liquid hydrogen and the oxidiser is liquid oxygen.

Preferably, the system is for use in a launch vehicle of a spacecraft or satellite.

### DESCRIPTION OF THE PREFERRED EMBODIMENT

The invention will now be described in greater detail, by way of example, with reference to the accompanying drawing, in which:

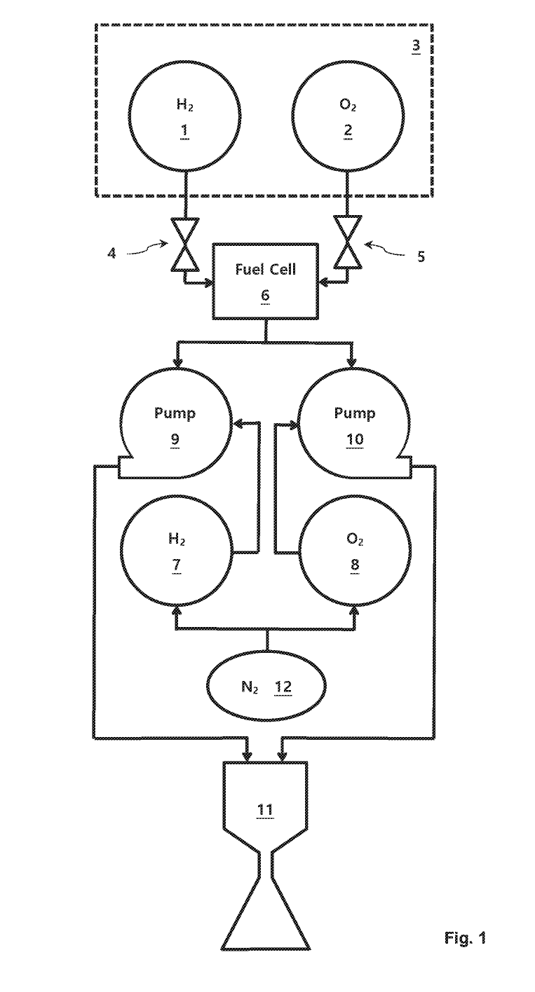

FIG. 1 is a schematic diagram of one form of system for feeding a liquid hydrogen and a liquid oxygen to combustion chamber of an engine, according to the invention.

As shown in FIG. 1, the system comprises: two tanks 1, 2, which are kept under a cryogenic temperature 3, i.e. −190° C. to −180° C., one 1 for holding liquid hydrogen, and the other one 2 for holding liquid oxygen; two expansion valves 4, 5, each of which are connected to one separate tank of said two tanks 1, 2, for transforming liquid hydrogen and liquid oxygen which pass through said valves 4, 5, into gaseous forms; a fuel cell 6, which includes proton exchange membrane, connected to said valves 4, 5, for receiving the gaseous hydrogen and gaseous oxygen, and generating electric power; two other tanks 7, 8, one 7 for holding liquid hydrogen, and the other one 8 for holding liquid oxygen; two electric pumps 9, 10 connected to said two other tanks 7, 8, such that one 9 of said pumps is capable of feeding the liquid hydrogen, and the other one 10 is capable of feeding the liquid oxygen, to the combustion chamber 11 of a rocket engine, using the power generated by said fuel cell 6; and one other tank 12 connected to said two other tanks 7, 8, for holding an inert gas, i.e. nitrogen gas or helium gas, and supplying the gas to said two other tanks 7, 8 for pushing the liquid hydrogen to said hydrogen pump 9 and the liquid oxygen to said oxygen pump 10.

The system may also comprise: a controller connected to said fuel cell 6 for controlling the voltage, current and temperature of the fuel cell 6; an ultracapacitor, which can be made of graphene, connected to the fuel cell 6 for storing the power generated by the fuel cell 6; and an injector plate manifold connected between said two pumps 9, 10 and the chamber 11, for receiving the liquid hydrogen and liquid oxygen in a stochiometric ratio, and feeding a mix of the liquid hydrogen and liquid oxygen to the chamber 11.

During operation, the cryogenic tanks 1, 2 discharge the liquid hydrogen and liquid oxygen. The liquids pass through the expansion valves 4, 5 which transform them into gaseous forms. The fuel cell 6 receives the gaseous hydrogen and gaseous oxygen, and generates electric power. The power generated is used by the electric pumps 9, 10 to supply the liquid hydrogen and liquid oxygen from the other two tanks 7, 8 to the injector plate manifold, in a stoichiometric ratio, and the inert gas is simultaneously supplied to the tanks to avoid formation of vacuum in the tanks 7, 8. Through the manifold, a mix of the liquid hydrogen and liquid oxygen is fed to the chamber 11 in which high voltage sparks ignite the liquid hydrogen and liquid oxygen.

One application of the system is for use in a launch vehicle of a spacecraft or satellite.

1. A system for feeding a liquid fuel and a liquid oxidiser to combustion chamber of an engine, comprising:
two containers kept under a low temperature, one for holding liquid hydrogen, and the other for holding liquid oxygen;
two expansion valves each connected to one separate container of said two containers, for transforming liquid hydrogen and liquid oxygen which pass through said valves into gaseous forms;
a fuel cell connected to said valves, for receiving the gaseous hydrogen and gaseous oxygen, and generating electric power;
two other containers, one for holding the fuel, and the other for holding the oxidiser; and
two electric pumps connected to said two other containers, such that one of said pumps is capable of feeding the fuel, and the other is capable of feeding the oxidizer to the chamber using the power generated by said fuel cell.

2. A system as claimed in claim 1, further comprising another container connected to said two other containers for holding at least one inert gas, and supplying the gas to said two other containers for pushing the fuel to said fuel pump and the oxidiser to said oxidiser pump.

3. A system as claimed in claim 1, wherein the temperature is in a range of −190° C. to −180° C.

4. A system as claimed in claim 1, wherein said fuel cell includes a proton exchange membrane.

5. A system as claimed in claim 1, wherein the fuel is liquid hydrogen and the oxidiser is liquid oxygen.

6. A system as claimed in claim 1, for use in a launch vehicle of a spacecraft or satellite.

7. A system as claimed in claim 2, wherein the temperature is in a range of −190° C. to −180° C.

8. A system as claimed in claim 7, wherein said fuel cell includes a proton exchange membrane.

9. A system as claimed in claim 8, wherein the fuel is liquid hydrogen and the oxidiser is liquid oxygen.

10. A system as claimed in claim 7, wherein the fuel is liquid hydrogen and the oxidiser is liquid oxygen.

11. A system as claimed in claim 2, wherein said fuel cell includes a proton exchange membrane.

12. A system as claimed in claim 11, wherein the fuel is liquid hydrogen and the oxidiser is liquid oxygen.

13. A system as claimed in claim 3, wherein said fuel cell includes a proton exchange membrane.

14. A system as claimed in claim 13, wherein the fuel is liquid hydrogen and the oxidiser is liquid oxygen.

15. A system as claimed in claim 2, wherein the fuel is liquid hydrogen and the oxidiser is liquid oxygen.

16. A system as claimed in claim 3, wherein the fuel is liquid hydrogen and the oxidiser is liquid oxygen.

17. A system as claimed in claim 4, wherein the fuel is liquid hydrogen and the oxidiser is liquid oxygen.
